(19) United States
(12) Patent Application Publication
(10) Pub. No.: US 2025/0380135 A1
(43) Pub. Date: Dec. 11, 2025

(54) SYSTEM FOR DISPLAY OF CONFIDENTIAL VISUAL CONTENT WITHOUT CLIENT DEVICE AUTHENTICATION

(71) Applicant: Truist Bank, Charlotte, NC (US)

(72) Inventor: Bastien Buchaca, Charlotte, NC (US)

(73) Assignee: Truist Bank, Charlotte, NC (US)

(21) Appl. No.: 19/307,381

(22) Filed: Aug. 22, 2025

Related U.S. Application Data
(63) Continuation-in-part of application No. 18/060,297, filed on Nov. 30, 2022.

(51) Int. Cl. H04W 12/06; H04W 12/02; H04W 12/37

(52) U.S. Cl. CPC H04W 12/06; H04W 12/02; H04W 12/37

(57) ABSTRACT

A system, computer program product, and method for managing access to confidential or sensitive user asset data by implementing a layered architecture that includes a mobile application engine, an entitlement engine, and an authentication engine, all operating in conjunction with a client device identification mechanism. This architecture enables the secure display of confidential user asset data on an unauthenticated registered client device by assigning and mapping a unique identifier to the client device, thereby eliminating the need for full authentication prior to data preview.

### CROSS-REFERENCE TO RELATED APPLICATIONS

The present application is a continuation-in-part of U.S. patent application Ser. No. 18/060,297 (filed on Nov. 30, 2022), the contents of which is hereby incorporated by reference in its complete entirety.

### TECHNICAL FIELD

The present disclosure relates to a system, computer program product, and method for managing access to confidential or sensitive user asset data by implementing a layered architecture that includes a mobile application engine, an entitlement engine, and an authentication engine, all operating in conjunction with a client device identification mechanism. This architecture enables the secure display of confidential user asset data on an unauthenticated registered client device by assigning and mapping a unique identifier to the client device, thereby eliminating the need for full authentication prior to data preview.

### BACKGROUND

In modern enterprise and mobile computing environments, user access to confidential or sensitive data, particularly asset-related information such as financial records, is typically governed by robust authentication mechanisms. These mechanisms are designed to ensure data integrity, confidentiality, and compliance with regulatory standards. The necessity, however, of full authentication prior to any access or interaction with such data introduces significant latency and user friction. This is especially problematic in scenarios where users require immediate access to critical information, such as account balances, transaction histories, or investment summaries, without the overhead of multi-factor authentication or biometric verification.

Current approaches to managing access to user asset data often rely on centralized authentication systems that enforce strict access controls. While these systems are effective in preventing unauthorized access, they do not provide a mechanism for secure data preview or partial access without full authentication. As a result, users are either required to complete a cumbersome authentication process before viewing any data or are presented with no information at all until authentication is complete. This dichotomy limits the usability of mobile applications in enterprise settings where rapid decision-making and real-time access are essential.

Moreover, existing systems that incorporate machine learning for user behavior analysis or predictive modeling typically focus on post-authentication personalization or fraud detection. These systems do not address the challenge of securely presenting asset-related data in a pre-authentication context. The integration of machine learning into authentication workflows has primarily aimed at improving the accuracy of fraud detection or reducing false positives in registration processes, rather than enabling secure, frictionless data previews.

The limitations of current systems are further exacerbated by the increasing reliance on mobile devices for enterprise and financial services. Mobile platforms often require a balance between security and usability that is difficult to achieve with traditional authentication paradigms. The absence of a secure method to provide limited visibility into user asset data without full authentication creates a gap in user experience and operational efficiency. This gap is particularly evident in applications where users may need to verify basic account information before proceeding with more confidential or sensitive actions, such as fund transfers or investment decisions. In summary, the existing landscape presents a challenge in reconciling the need for strong security with the demand for seamless user interaction. The lack of a secure yet efficient mechanism for previewing user asset data without full authentication continues to hinder the adoption and usability of mobile enterprise applications. Addressing this challenge requires a reevaluation of how authentication and data access are managed in asset-sensitive environments.

### SUMMARY

The present disclosure introduces a secure approach to managing access to confidential or sensitive user asset data by implementing a layered architecture that includes a plurality of processor-implemented engines that operate in conjunction with a unique client device identification mechanism. This architecture facilitates the secure display of user asset data on an unauthenticated registered client device by generating, assigning, and mapping a unique identifier to the client device, thereby eliminating the need for full authentication prior to data preview. Unlike conventional systems that rely solely on user credentials or session tokens, the system leverages one or more device-specific entitlement rules that are dynamically applied based on pre-registered client device entitlement data. This results in a more streamlined and secure access model, particularly in enterprise settings where rapid access to information is critical.

Integration of an entitlement engine that stores and applies authorization rules based on device identity rather than user identity provides a more scalable and flexible access control mechanism. Traditional authentication systems often impose latency and complexity due to the need for repeated verification of user credentials. In contrast, the described system allows for conditional access based on device-specific entitlements, which can be pre-established and validated without requiring real-time user authentication. This not only enhances the user experience by reducing friction during initial access but also improves security by limiting exposure of confidential or sensitive data to only those devices that have been explicitly authorized. The use of entitlement rules in conjunction with device identifiers represents a significant technical advancement in secure, low-latency data access frameworks.

In accordance with one or more embodiments set forth, illustrated, and described herein, a server computing system comprises one or more of the following: one or more mobile application server computers including a plurality of processor-implemented engines including a mobile application engine for an enterprise mobile application, an authentication engine having general user authentication protocols for the enterprise mobile application, and an entitlement engine, one or more processors, and a non-transitory memory coupled to the one or more processors, the non-transitory memory including a set of instructions of computer-executable program code, which when executed by the one or more processors, cause the one or more processors to perform operations including: transmitting/sending a command to the mobile application engine to display, via the enterprise mobile application, a client device registration GUI on a client device, the client device registration GUI having a plurality of input data fields to acquire client device registration data that registers the client device with the enterprise mobile application as a registered client device; storing, by the mobile application engine, the client device registration data at a data storage location; generating, by the mobile application engine, a random unique identifier associated with a registered client device as a client device ID; storing, by the mobile application engine, the client device ID at a data storage location; transmitting/sending a command to the entitlement engine to display, via the enterprise mobile application, a client device entitlement GUI on the UI of the registered client device, the client device entitlement GUI having a plurality of input data fields to acquire client device entitlement data including an authorization to display confidential visual content associated with a user account on the UI of the registered client device in an unauthenticated state as an unauthenticated registered client device; storing the client device entitlement data at the data storage location; automatically generating, by the mobile application engine, an entitlement data structure associating the client device ID with the client device entitlement data; assigning, by the entitlement engine, an entitlement rule based on the client device entitlement data; detecting a (re)launching of the enterprise mobile application by the unauthenticated registered client device; verifying the identity of the unauthenticated registered client device by mapping the unauthenticated registered client device to the client device ID; automatically deploying the entitlement rule associated with the unauthenticated registered client device; and transmitting a push notification that displays the confidential visual content on the UI of the unauthenticated registered client device.

In accordance with one or more embodiments set forth, illustrated, and described herein, a server computing system comprises one or more of the following: one or more mobile application server computers including a plurality of processor-implemented engines including a mobile application engine for an enterprise mobile application, an authentication engine having general user authentication protocols for the enterprise mobile application, and an entitlement engine, one or more processors, and a non-transitory memory coupled to the one or more processors, the non-transitory memory including a set of instructions of computer-executable program code, which when executed by the one or more processors, cause the one or more processors to perform operations including: generating, by the mobile application engine, a random unique identifier associated with a registered client device as a client device ID; assigning, by the entitlement engine, an entitlement rule based on the client device entitlement data; detecting a (re)launching of the enterprise mobile application by the unauthenticated registered client device; automatically deploying the entitlement rule associated with the unauthenticated registered client device; and transmitting a push notification that displays the confidential visual content on the UI of the unauthenticated registered client device.

In accordance with one or more embodiments set forth, illustrated, and described herein, a server computing system comprises one or more of the following: one or more mobile application server computers including a plurality of processor-implemented engines including a mobile application engine for an enterprise mobile application, an authentication engine having general user authentication protocols for the enterprise mobile application, and an entitlement engine, one or more processors, and a non-transitory memory coupled to the one or more processors, the non-transitory memory including a set of instructions of computer-executable program code, which when executed by the one or more processors, cause the one or more processors to perform operations including: generating, by the mobile application engine, a random unique identifier associated with a registered client device as a client device ID; assigning, by the entitlement engine, an entitlement rule based on the client device entitlement data; detecting a (re)launching of the enterprise mobile application by the unauthenticated registered client device; automatically deploying the entitlement rule associated with the unauthenticated registered client device; transmitting a push notification that displays the confidential visual content on the UI of the unauthenticated registered client device; receiving a signal indicating the expiration of a predetermined period of time of display of the push notification; and automatically removing the push notification.

In accordance with one or more embodiments set forth, illustrated, and described herein, a server computing system comprises one or more of the following: one or more mobile application server computers including a plurality of processor-implemented engines including a mobile application engine for an enterprise mobile application, an authentication engine having general user authentication protocols for the enterprise mobile application, and an entitlement engine, one or more processors, and a non-transitory memory coupled to the one or more processors, the non-transitory memory including a set of instructions of computer-executable program code, which when executed by the one or more processors, cause the one or more processors to perform operations including: generating, by the mobile application engine, a random unique identifier associated with a registered client device as a client device ID; assigning, by the entitlement engine, an entitlement rule based on the client device entitlement data; detecting a (re)launching of the enterprise mobile application by the unauthenticated registered client device; automatically deploying the entitlement rule associated with the unauthenticated registered client device; transmitting a push notification that displays the confidential visual content on the UI of the unauthenticated registered client device; detecting an overlapping condition in which the displayed confidential visual content overlaps displayed visual content on a GUI of the enterprise mobile application; automatically relocating, in response to the detection, the confidential visual content to an alternative region that does not present an overlapping condition.

In accordance with one or more embodiments set forth, illustrated, and described herein, a method for implementation by a server computing system, the method by comprising one or more of the following: transmitting/sending a command to a mobile application engine of the server computing system to display, via an enterprise mobile application of the server computing system to display, a client device registration GUI on a client device, the client device registration GUI having a plurality of input data fields to acquire client device registration data that registers the client device with the enterprise mobile application as a registered client device; storing, by the mobile application engine, the client device registration data at a data storage location; generating, by the mobile application engine, a random unique identifier associated with a registered client device as a client device ID; storing, by the mobile application engine, the client device ID at a data storage location; transmitting/sending a command to the entitlement engine to display, via an enterprise mobile application of the server computing system, a client device entitlement GUI on the UI of the registered client device, the client device entitlement GUI having a plurality of input data fields to acquire client device entitlement data including an authorization to display confidential visual content associated with a user account on the UI of the registered client device in an unauthenticated state as an unauthenticated registered client device; storing the client device entitlement data at the data storage location; automatically generating, by the mobile application engine, an entitlement data structure associating the client device ID with the client device entitlement data; assigning, by the entitlement engine, an entitlement rule based on the client device entitlement data; detecting a (re)launching of the enterprise mobile application by the unauthenticated registered client device; verifying the identity of the unauthenticated registered client device by mapping the unauthenticated registered client device to the client device ID; automatically deploying the entitlement rule associated with the unauthenticated registered client device; and transmitting a push notification that displays the confidential visual content on the UI of the unauthenticated registered client device.

In accordance with one or more embodiments set forth, illustrated, and described herein, a method for implementation by a server computing system, the method by comprising one or more of the following: generating, by a mobile application engine of the server computing system, a random unique identifier associated with a registered client device as a client device ID; assigning, by an entitlement engine of the server computing system, an entitlement rule based on the client device entitlement data; detecting a (re)launching of the enterprise mobile application by the unauthenticated registered client device; automatically deploying the entitlement rule associated with the unauthenticated registered client device; and transmitting a push notification that displays the confidential visual content on the UI of the unauthenticated registered client device.

In accordance with one or more embodiments set forth, illustrated, and described herein, a method for implementation by a server computing system, the method by comprising one or more of the following: generating, by a mobile application engine of the server computing system, a random unique identifier associated with a registered client device as a client device ID; assigning, by an entitlement engine of the server computing system, an entitlement rule based on the client device entitlement data; detecting a (re)launching of the enterprise mobile application by the unauthenticated registered client device; automatically deploying the entitlement rule associated with the unauthenticated registered client device; transmitting a push notification that displays the confidential visual content on the UI of the unauthenticated registered client device; receiving a signal indicating the expiration of a predetermined period of time of display of the push notification; and automatically removing the push notification.

In accordance with one or more embodiments set forth, illustrated, and described herein, a method for implementation by a server computing system, the method by comprising one or more of the following: generating, by a mobile application engine of the server computing system, a random unique identifier associated with a registered client device as a client device ID; assigning, by an entitlement engine of the server computing system, an entitlement rule based on the client device entitlement data; detecting a (re)launching of the enterprise mobile application by the unauthenticated registered client device; automatically deploying the entitlement rule associated with the unauthenticated registered client device; transmitting a push notification that displays the confidential visual content on the UI of the unauthenticated registered client device; detecting an overlapping condition in which the displayed confidential visual content overlaps displayed visual content on a GUI of the enterprise mobile application; automatically relocating, in response to the detection, the confidential visual content to an alternative region that does not present an overlapping condition.

In accordance with one or more embodiments set forth, illustrated, and described herein, a computer program product comprising at least one non-transitory computer readable medium having with a set of instructions of computer-executable program code, which when executed by one or more processors of a server computing system, cause the one or more processors to perform operations including: transmitting/sending a command to a mobile application engine of the server computing system to display, via an enterprise mobile application of the server computing system to display, a client device registration GUI on a client device, the client device registration GUI having a plurality of input data fields to acquire client device registration data that registers the client device with the enterprise mobile application as a registered client device; storing, by the mobile application engine, the client device registration data at a data storage location; generating, by the mobile application engine, a random unique identifier associated with a registered client device as a client device ID; storing, by the mobile application engine, the client device ID at a data storage location; transmitting/sending a command to the entitlement engine to display, via an enterprise mobile application of the server computing system, a client device entitlement GUI on the UI of the registered client device, the client device entitlement GUI having a plurality of input data fields to acquire client device entitlement data including an authorization to display confidential visual content associated with a user account on the UI of the registered client device in an unauthenticated state as an unauthenticated registered client device; storing the client device entitlement data at the data storage location; automatically generating, by the mobile application engine, an entitlement data structure associating the client device ID with the client device entitlement data; assigning, by the entitlement engine, an entitlement rule based on the client device entitlement data; detecting a (re)launching of the enterprise mobile application by the unauthenticated registered client device; verifying the identity of the unauthenticated registered client device by mapping the unauthenticated registered client device to the client device ID; automatically deploying the entitlement rule associated with the unauthenticated registered client device; and transmitting a push notification that displays the confidential visual content on the UI of the unauthenticated registered client device.

In accordance with one or more embodiments set forth, illustrated, and described herein, a computer program product comprising at least one non-transitory computer readable medium having with a set of instructions of computer-executable program code, which when executed by one or more processors of a server computing system, cause the one or more processors to perform operations including: generating, by a mobile application engine of the server computing system, a random unique identifier associated with a registered client device as a client device ID; assigning, by an entitlement engine of the server computing system, an entitlement rule based on the client device entitlement data; detecting a (re)launching of the enterprise mobile application by the unauthenticated registered client device; automatically deploying the entitlement rule associated with the unauthenticated registered client device; and transmitting a push notification that displays the confidential visual content on the UI of the unauthenticated registered client device.

In accordance with one or more embodiments set forth, illustrated, and described herein, a computer program product comprising at least one non-transitory computer readable medium having with a set of instructions of computer-executable program code, which when executed by one or more processors of a server computing system, cause the one or more processors to perform operations including: generating, by a mobile application engine of the server computing system, a random unique identifier associated with a registered client device as a client device ID; assigning, by an entitlement engine of the server computing system, an entitlement rule based on the client device entitlement data; detecting a (re)launching of the enterprise mobile application by the unauthenticated registered client device; automatically deploying the entitlement rule associated with the unauthenticated registered client device; transmitting a push notification that displays the confidential visual content on the UI of the unauthenticated registered client device; receiving a signal indicating the expiration of a predetermined period of time of display of the push notification; and automatically removing the push notification.

In accordance with one or more embodiments set forth, illustrated, and described herein, a computer program product comprising at least one non-transitory computer readable medium having with a set of instructions of computer-executable program code, which when executed by one or more processors of a server computing system, cause the one or more processors to perform operations including: generating, by a mobile application engine of the server computing system, a random unique identifier associated with a registered client device as a client device ID; assigning, by an entitlement engine of the server computing system, an entitlement rule based on the client device entitlement data; detecting a (re)launching of the enterprise mobile application by the unauthenticated registered client device; automatically deploying the entitlement rule associated with the unauthenticated registered client device; transmitting a push notification that displays the confidential visual content on the UI of the unauthenticated registered client device; detecting an overlapping condition in which the displayed confidential visual content overlaps displayed visual content on a GUI of the enterprise mobile application; automatically relocating, in response to the detection, the confidential visual content to an alternative region that does not present an overlapping condition.

In accordance with one or more embodiments set forth, illustrated, and described herein, the push notification is displayed on the UI of the unauthenticated registered client device for a predetermined time value that is stored at a storage location.

In accordance with one or more embodiments set forth, illustrated, and described herein, the set of instructions, which when executed by the one or more processors, cause the one or more processors to perform further operations including receiving a signal from a clock indicating the expiration of the predetermined time value.

In accordance with one or more embodiments set forth, illustrated, and described herein, the set of instructions, which when executed by the one or more processors, cause the one or more processors to perform further operations including automatically removing the push notification.

In accordance with one or more embodiments set forth, illustrated, and described herein, the push notification is superimposed on a GUI of the enterprise mobile application.

In accordance with one or more embodiments set forth, illustrated, and described herein, the push notification is superimposed on a GUI of the enterprise mobile application at a predetermined region of the UI of the unauthenticated registered client device.

In accordance with one or more embodiments set forth, illustrated, and described herein, the predetermined region does not display visual content to be overlapped by the push notification.

In accordance with one or more embodiments set forth, illustrated, and described herein, the push notification is superimposed on a GUI of the enterprise mobile application at a randomly selected region of the UI of the unauthenticated registered client device.

In accordance with one or more embodiments set forth, illustrated, and described herein, the confidential visual content comprises current user asset data.

In accordance with one or more embodiments set forth, illustrated, and described herein, the confidential visual content comprises user account transaction history.

In accordance with one or more embodiments set forth, illustrated, and described herein, detecting the launching comprises receiving an applications launch event signal from the mobile application engine indicating the launching of the enterprise mobile application by the unauthenticated registered client device.

In accordance with one or more embodiments set forth, illustrated, and described herein, detecting the launching of the enterprise mobile application comprises receiving a backend call from an application program interface (API) indicating the launching of the enterprise mobile application by the unauthenticated registered client device.

### DRAWINGS

The various advantages of the exemplary embodiments will become apparent to one skilled in the art by reading the following specification and appended claims, and by referencing the following drawings, in which:

FIG. 1 illustrates a communication environment, in accordance with one or more embodiments set forth and described herein.

FIG. 2 illustrates a block diagram of the client device of FIG. 1.

FIG. 3 illustrates a block diagram of the one or more servers of a server computing system of FIG. 1.

FIG. 4 illustrates a client device authentication GUI for display on a UI of the client device.

FIG. 5 illustrates a client device/user profile registration GUI for display on the UI of the client device.

FIG. 6 illustrates a client device/user profile settings/entitlements GUI for display on the UI of the client device.

FIG. 7 illustrates an updated client device/user profile settings/entitlements GUI for display on the UI of the client device.

FIG. 8 illustrates a user account dashboard for visual display on the UI of the client device.

FIG. 9 illustrates an updated client device/user profile registration GUI for display on the UI of the client device.

FIG. 10 illustrates an updated GUI comprising the enterprise mobile application home dashboard, in accordance with one or more embodiments set forth and described herein.

FIG. 11 illustrates a balance preview dashboard having one or more tiles that visually display one or more user account balances without user authentication, in accordance with one or more embodiments set forth and described herein.

FIGS. 12 through 15 respectively illustrate a computer-implemented method, in accordance with one or more embodiments set forth and described herein.

### DESCRIPTION

The present disclosure introduces a secure approach to managing access to confidential or sensitive content (e.g., user asset data) by implementing a layered architecture that includes a mobile application engine, an entitlement engine, and an authentication engine, all operating in conjunction with a client device identification mechanism. This architecture enables the secure display of user asset data on an unauthenticated client device by assigning and mapping a unique identifier to the client device, thereby eliminating the need for full authentication prior to data preview. Unlike conventional systems that rely solely on user credentials or session tokens, such architecture leverages device-specific entitlement rules that are dynamically applied based on pre-registered client device entitlement data. This results in a more streamlined and secure access model, particularly in enterprise settings where rapid access to information is critical.

Integration of an entitlement engine that stores and applies authorization rules based on device identity rather than user identity provides a more scalable and flexible access control mechanism. Traditional authentication systems often impose latency and complexity due to the need for repeated verification of user credentials. In contrast, the described system allows for conditional access based on device-specific entitlements, which can be pre-established and validated without requiring real-time user authentication. This not only enhances the user experience by reducing friction during initial access but also improves security by limiting exposure of confidential or sensitive data to only those devices that have been explicitly authorized. The use of entitlement rules in conjunction with device identifiers represents a significant technical advancement in secure, low-latency data access frameworks.

Hereinbelow are example definitions that are provided only for illustrative purposes in this disclosure, and should not be construed to limit the scope of the one or more embodiments disclosed herein in any manner. Some terms are defined below for purposes of clarity. These terms are not rigidly restricted to these definitions. This disclosure contemplates that these terms and other terms may also be defined by their use in the context of this description.

As used herein, “application” relates to software used on a computer (usually by a client and/or client device and can be applications that are targeted or supported by specific classes of machine, such as a mobile application, desktop application, tablet application, and/or enterprise application (e.g., client device application(s) on a client device). Applications may be separated into applications which reside on a client device (e.g., VPN, PowerPoint, Excel) and cloud applications which may reside in the cloud (e.g., Gmail, GitHub). Cloud applications may correspond to applications on the client device or may be other types such as social media applications (e.g., Facebook).

As used herein, “artificial intelligence (AI)” relates to one or more computer system operable to perform one or more tasks that normally require human intelligence, such as visual perception, speech recognition, decision-making, and translation between languages.

As used herein, “dynamically” relates to events or actions that can be caused, triggered, or otherwise occur without human intervention.

As used herein, “machine learning” relates to an application of AI that provides computer systems the ability to automatically learn and improve from data and experience without being explicitly programmed.

As used herein, “computer” relates to a single computer or to a system of interacting computers. A computer is a combination of a hardware system, a software operating system and perhaps one or more software application programs. Examples of a computer include without limitation a personal computer (PC), laptop computer, a smart phone, a cell phone, or a wireless tablet.

As used herein, “client device” relates to any device associated with a user, including personal computers, laptops, tablets, and/or mobile smartphones.

As used herein, “modules” relates to either software modules (e.g., code embodied on a machine-readable medium or in a transmission signal) or hardware modules. Certain embodiments are described herein as including logic or a number of components, modules, or mechanisms. A “hardware module” (or just “hardware”) as used herein is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as an FPGA or an ASIC. A hardware module may also include programmable logic or circuitry that is temporarily configured by software to perform certain operations. A hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access.

As used herein, “network” or “networks” relates to any combination of electronic communication networks, including without limitation the Internet, a local area network (LAN), a wide area network, a wireless network, and a cellular network (e.g., 4G, 5G).

As used herein, “processes” or “methods” are presented in terms of processes (or methods) or symbolic representations of operations on data stored as bits or binary digital signals within a machine memory (e.g., a computer memory). These processes or symbolic representations are examples of techniques used by those of ordinary skill in the data processing arts to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “processor-implemented module” relates to a hardware module implemented using one or more processors. The various operations of example methods described herein may be performed, at least partially, by one or more processors that are temporarily configured (e.g., by software) or permanently configured to perform the relevant operations. Whether temporarily or permanently configured, such processors may constitute processor-implemented modules or engines that operate to perform one or more operations or functions described herein.

As used herein, “server” relates to a server computer or group of computers that acts to provide a service for a certain function or access to a network resource. A server may be a physical server, a hosted server in a virtual environment, or software code running on a platform.

As used herein, “service” or “application” relates to an online server (or set of servers), and can refer to a web site and/or web application.

As used herein, “software” relates to a set of instructions and associated documentations that tells a computer what to do or how to perform a task. Software includes all different software programs on a computer, such as applications and the operating system. A software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++, CGI, Java, and Java Scripts. Further, the functions of some embodiments, when described as a series of steps for a method, could be implemented as a series of software instructions for being operated by a processor, such that the embodiments could be implemented as software, hardware, or a combination thereof.

As used herein, “sensor” relates to any device, component and/or system that can perform one or more of detecting, determining, assessing, monitoring, measuring, quantifying, and sensing something.

As used herein, “real-time” relates to a level of processing responsiveness that a user, module, or system senses as sufficiently immediate for a particular process or determination to be made, or that enables the processor to keep up with some external process.

As used herein, “user” relates to a consumer, machine entity, and/or requesting party, and may be human or machine.

As used herein, “widget” relates to electronic visual tiles that may be added to a home screen dashboard that are bigger than a regular application icon and have additional functionality. The widget may include shortcuts directly to popular features within an enterprise mobile application.

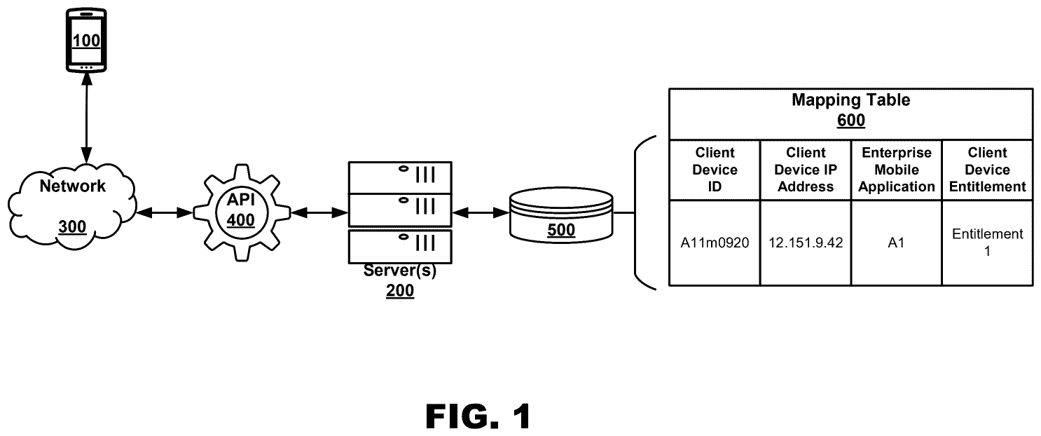

Turning to the figures, in which FIG. 1 illustrates a communication environment in which a user communicates with an enterprise over a communications network. A client device 100 operating in the communication environment facilitates user access to and user management of one or more user accounts at one or more mobile application servers 200 of the enterprise. The communication environment includes the client device 100, the one or more mobile application servers 200, an application programming interface (API) 400 that communicates with the client device 100 via a communications network 300, and a storage location such as one or more databases 500.

In accordance with one or more embodiments set forth, described, and/or illustrated herein, the client device 100 comprises a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the client device 100 comprising any form of electronic device that optimizes or otherwise transforms the performance and functionality of the one or more embodiments in a manner that falls within the spirit and scope of the principles of this disclosure.

In accordance with one or more embodiments set forth, described, and/or illustrated herein, each server in the one or more mobile application servers 200 comprises a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the one or more mobile application servers 200 comprising any form of electronic device that optimizes or otherwise transforms the performance and functionality of the one or more embodiments in a manner that falls within the spirit and scope of the principles of this disclosure.

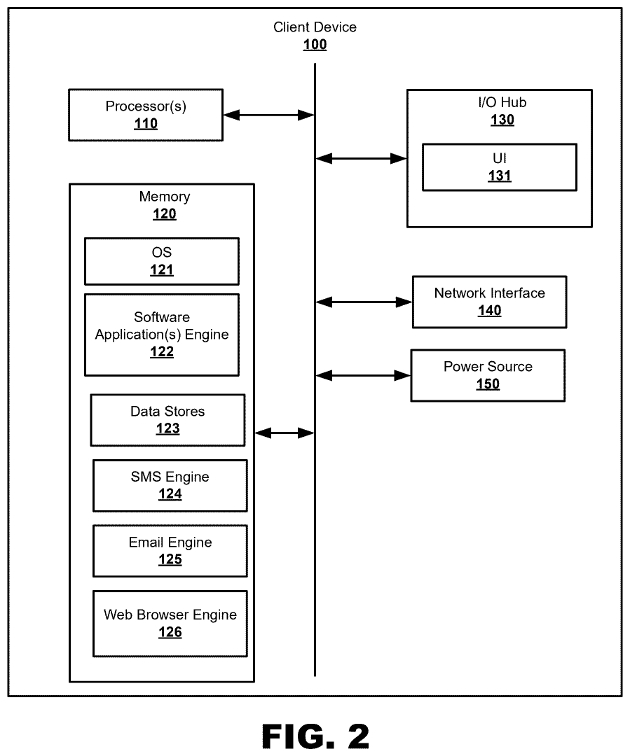

In the illustrated example embodiment of FIGS. 1 and 2, the client device 100 comprises a mobile device. Some of the possible operational elements of the client device 100 are illustrated in FIG. 2 and will now be described herein. It will be understood that it is not necessary for the client device 100 to have all the elements illustrated in FIG. 2. For example, the client device 100 may have any combination of the various elements illustrated in FIG. 2. Moreover, the client device 100 may have additional elements to those illustrated in FIG. 2.

The client device 100 includes one or more processors 110, a non-transitory memory 120 operatively coupled to the one or more processors 110, an I/O hub 130, a network interface 140, and a power source 150.

The memory 120 comprises a set of instructions of computer-executable program code. The set of instructions are executable by the one or more processors 110 to cause execution of an operating system 121 and one or more software applications of a software application module 122 that reside in the memory 120. The one or more software applications residing in the memory 120 includes, but is not limited to, a client or enterprise mobile application that is associated with the enterprise. The enterprise mobile application facilitates establishment of a secure connection between the client device 100 and the one or more mobile application servers 200. The one or more processors 110 are operable to execute the enterprise mobile application to facilitate user access to the one or more user accounts and user management of the one or more user accounts that are maintained by the enterprise.

The memory 120 also includes one or more data stores 123 that are operable to store one or more types of data. The client device 100 may include one or more interfaces that facilitate one or more systems or modules thereof to transform, manage, retrieve, modify, add, or delete, the data residing in the data stores 123. The one or more data stores 123 may comprise volatile and/or non-volatile memory. Examples of suitable data stores 123 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 123 may be a component of the one or more processors 110, or alternatively, may be operatively connected to the one or more processors 110 for use thereby. As set forth, described, and/or illustrated herein, “operatively connected” may include direct or indirect connections, including connections without direct physical contact.

The memory 120 also includes an SMS module 124 operable to facilitate user transmission and receipt of text messages via the client device 100 though the network 300. In one example embodiment, a user may receive text messages from the enterprise that are associated with the user access and the user management of the one or more user accounts. An email module 125 is operable to facilitate user transmission and receipt of email messages via the client device 100 through the network 300. In one example embodiment, a user may receive email messages from the enterprise that are associated with the user access and the user management of the one or more user accounts. A user may utilize a web browser module 126 that is operable to facilitate user access to one or more websites associated with the enterprise through the network 300.

In accordance with one or more embodiments set forth, described, and/or illustrated herein, the client device 100 includes an I/O hub 130 operatively connected to other systems and subsystems of the client device 100. The I/O system 130 may include one or more of an input interface, an output interface, and a network controller to facilitate communications between the client device 100 and the server 200. The input interface and the output interface may be integrated as a single, unitary user interface 131, or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 110 to execute instructions. The input interface may comprise a user interface (UI), a graphical user interface (GUI), such as, for example, display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the client device 100 may serve as both a component of the input interface and a component of the output interface.

The client device 100 includes a network interface 140 operable to facilitate connection to the network 300. The client device 100 also includes power source 150 that comprises a wired powered source, a wireless power source, a replaceable battery source, or a rechargeable battery source.

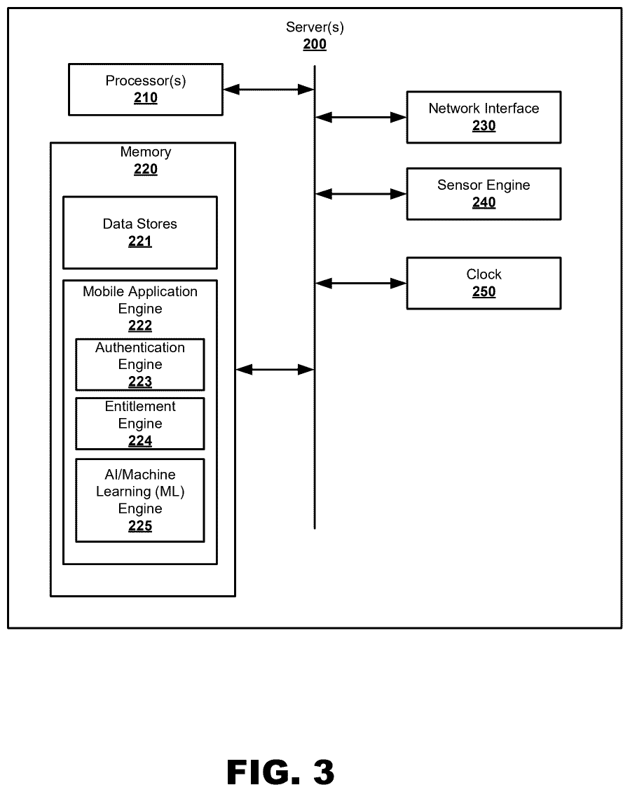

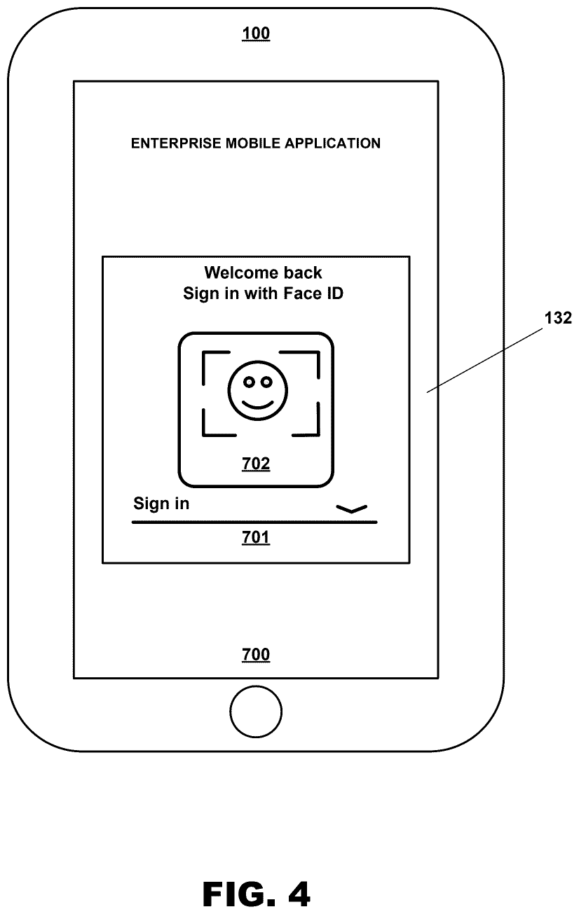

As illustrated in FIG. 3, the one or more mobile application servers 200 includes one or more processors 210, a non-transitory memory 220 operatively coupled to the one or more processors 210, a network interface 230, a sensor engine 240, and a clock 250 that is operable to perform time/temporal measurements. Some of the possible operational elements of each server in the one or more mobile application servers 200 are illustrated in FIG. 4 and will now be described herein. It will be understood that it is not necessary for each server in the one or more mobile application servers 200 to have all the elements illustrated in FIG. 3. For example, each server in the one or more mobile application servers 200 may have any combination of the various elements illustrated in FIG. 3. Moreover, each server in the one or more mobile application servers 200 may have additional elements to those illustrated in FIG. 3.

In accordance with one or more embodiments set forth, the one or more processors 210 may comprise artificial intelligence (AI) processors, machine learning (ML) processors, and combinations thereof that are operable to perform or otherwise implement accelerated processing of the one or more methods set forth and described herein.

In accordance with one or more embodiments set forth, described, and/or illustrated herein, the one or more mobile application servers 200 may be controlled by an enterprise system manager (or policy manager).

In accordance with one or more embodiments set forth, described, and/or illustrated herein, the one or more mobile application servers 200 may comprise a computing device, including but not limited to a server computer, a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the one or more mobile application servers 200 comprising any form of electronic device that optimizes or otherwise transforms the performance and functionality of the one or more embodiments in a manner that falls within the spirit and scope of the principles of this disclosure.

The memory 220 includes one or more data stores 221 that are operable to store one or more types of data, including but not limited to, user account data, client device authentication data, client device entitlement data, sensor data, etc. The one or more data stores 221 may comprise volatile and/or non-volatile memory. Examples of suitable data stores 221 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 221 may be a component of the one or more processors 210, or alternatively, may be operatively connected to the one or more processors 210 for use thereby. As set forth, described, and/or illustrated herein, “operatively connected” may include direct or indirect connections, including connections without direct physical contact.

The memory 220 further comprises a set of instructions of computer-executable program code. The set of instructions are executable by the one or more processors 210 in manner that facilitates control of a plurality of processor-implemented engines that includes a mobile application engine 222, an authentication engine 223, an entitlement engine 224, and an AI/ML engine 225 that reside in the memory 220. In accordance with one or more embodiments set forth, described, and/or illustrated herein, the one or more mobile application servers 200 may individually or collectively execute the instructions to perform or otherwise implement any one or more of the methodologies set forth, described, and illustrated herein. The memory 220 may store a lookup table or mapping table that associates the client device 100 to the assigned client device ID and any entitlements associated with the user account.

The memory 220 may include a single machine-readable medium, or a plurality of media (e.g., a centralized or distributed database, or associated caches and servers) operable to store the instructions. The term “machine-readable medium” shall also be taken to include any medium, or combination of multiple media, that is capable of storing instructions (e.g., software) for execution by the one or more mobile application servers 200, such that the instructions, when executed by the one or more processors 210, cause the one or more processors 210 to perform any one or more of the methodologies set forth, described, and illustrated herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

The computer-executable program code may instruct the one or more processors 210 to execute certain logic, data-processing, and data-storing functions of the one or more mobile application servers 200, in addition to certain communication functions of the one or more mobile application servers 200. The mobile application engine 222, via the API 400, is operable to communicate with the client device 100 (having launched the enterprise mobile application) in a manner which facilitates user access to the one or more user accounts in addition to user management of the one or more user accounts based on successful client device authentication. The data exchanged between the client device 100 and the one or more mobile application servers 200 may be encrypted during communications therebetween.

The authentication engine 223 is operable to verify the identity of the client device 100 by implementing one or more authentication protocols that map client device authentication credentials to stored authentication credentials. The authentication protocols may include multi-factor authentication, biometric authentication, password-based authentication, token-based biometric authentication, etc.

The entitlement engine 224 is operable to acquire client device entitlement data of a registered client device, and store the client device entitlement data at a data storage location (e.g., data stores 221 and/or one or more databases 500). The entitlement engine 224 includes one or more entitlement or permission rules that are associated with the client device entitlement data. The entitlement data may include, inter alia, an authorization to bypass general user authentication protocols implemented by the authentication engine 223 to thereby display confidential or sensitive account content (e.g., confidential or sensitive user asset data) on a client device 100 that is unauthenticated.

The AI/ML engine 225 may comprise one or more AI/ML processors operable to perform or otherwise implement accelerated processing of the one or more methods set forth and described herein. The one or more AI/ML processors are operable to perform operations involving machine learning (ML) by generating a trained ML model. The AI/ML engine 225 include one or more ML algorithms to train one or more machine learning models as a trained ML model based on data and/or information residing in the memory 220 and/or one or more storage locations (e.g., one or more databases 500). The ML algorithms may include one or more of a linear regression algorithm, a logical regression algorithm, or a combination of different algorithms. A neural network may also be used to train the system based on the received data. The AI/ML engine 225 may analyze the received data and/or information, and transform the data and/or information in a manner which provides enhanced communication between the client device 100 and the one or more mobile application servers 200, while also enhancing user access and user management of the one or more user accounts. The data and/or information may also be up-linked to other systems and modules in the one or more mobile application servers 200 for further processing to discover additional information that may be used to enhance the understanding of the information.

The sensor engine 240 is operable, at least during execution of the mobile application by the client device 100, to dynamically detect, determine, assess, monitor, measure, quantify, and/or sense information about the client device 100. The sensor module 240 may be operable to detect, determine, assess, monitor, measure, quantify and/or sense in real-time. The sensor engine 240 may be operable to detect, determine, assess, monitor, measure, quantify, and/or sense geographic location information about the geographic location of the client device 100.

In accordance with one or more embodiments set forth, described, and/or illustrated herein, the network 300 may comprise a wireless network, a wired network, or any suitable combination thereof. For example, the network 300 is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

In accordance with one or more embodiments set forth, described, and/or illustrated herein, the client device 100 and the one or more mobile application server(s) 200 could function in a fully virtualized environment. A virtual machine is where all hardware is virtual and operation is run over a virtual processor. The benefits of computer virtualization have been recognized as greatly increasing the computational efficiency and flexibility of a computing hardware platform. For example, computer virtualization facilitates multiple virtual computing machines to execute on a common computing hardware platform. Similar to a physical computing hardware platform, virtual computing machines include storage media, such as virtual hard disks, virtual processors, and other system components associated with a computing environment. For example, a virtual hard disk can store the operating system, data, and application files for a virtual machine. Virtualized computer system includes computing device or physical hardware platform, virtualization software running on hardware platform, and one or more virtual machines running on hardware platform by way of virtualization software. Virtualization software is therefore logically interposed between the physical hardware of hardware platform and guest system software running “in” virtual machine. Memory of the hardware platform may store virtualization software and guest system software running in virtual machine. Virtualization software performs system resource management and virtual machine emulation. Virtual machine emulation may be performed by a virtual machine monitor (VMM) component. In typical implementations, each virtual machine (only one shown) has a corresponding VMM instance. Depending on implementation, virtualization software may be unhosted or hosted. Unhosted virtualization software generally relies on a specialized virtualization kernel for managing system resources, whereas hosted virtualization software relies on a commodity operating system: the “host operating system,” such as Windows or Linux to manage system resources. In a hosted virtualization system, the host operating system may be considered as part of virtualization software.

Any apparatus, computing device, computer program product, and computer-implemented method described herein may be at least partially processor-implemented, the one or more processors 210 being an example of hardware. For example, at least some of the operations of a method may be performed by one or more processors 210 or processor-implemented modules or engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., the API 400).

The performance of certain of the operations may be distributed among the one or more processors 210, not only residing within a single machine, but deployed across a plurality of machines. In some example embodiments, the one or more processors 210 or processor-implemented modules or engines may be located in a single geographic location (e.g., within a home environment, an office environment, or a server farm). In other example embodiments, the one or more processors or processor-implemented modules or engines may be distributed across a plurality of geographic locations.

In accordance with one or more embodiments set forth, described, and/or illustrated herein, a user may, via the I/O hub 130 of the client device 100, launch or initialize execution of an enterprise mobile application over the communication network 300 for the purpose of registering a user profile. The user may already have one or more user accounts that are maintained by the enterprise, or otherwise seek to open one or more new accounts with the enterprise.

As illustrated in FIG. 4, the launching of the enterprise mobile application by the client device 100 results in the computer-executable program code instructing the one or more processors 210 to generate, display, or render a homepage GUI 700 for an enterprise mobile application. The homepage GUI 700 includes a widget comprising a sign-in icon 701 that includes a user-engageable arrowhead that allows the user (via the client device 100) to log into an existing user account, or create a new user account. The widget also includes a biometric data field 702 that permits biometric authentication using user biometric data.

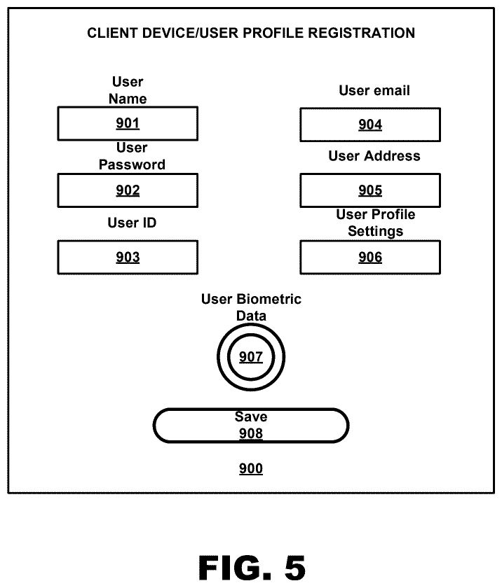

As illustrated in FIG. 5, the computer-executable program code may instruct the one or more processors 210 to transmit a command to the authentication engine 223 to display, generate, or render a client device/user profile registration GUI 900 for visual display on the UI 132 of the client device 100. The computer-executable program code may instruct the one or more processors 210 to transmit a command to the authentication engine 223 to generate or otherwise render a plurality of user input fields on the user profile registration dashboard to be populated by the user (via the client device 100) as client device authentication data to facilitate registration of a user profile and authentication credentials with the enterprise. The plurality of user input fields includes, but is not limited to, a username input field 901, a user password input field 902, a user identification (ID) input field 903, a user email input field 904, a user address input field 905, a user profile settings input field 906, and a user biometric data field 907 (facial, fingerprint, voice, ocular, etc.). This disclosure contemplates visual presentation of the plurality of user input fields in any relevant combination. User engagement of a save icon 908 causes the storing of the client device authentication data at a storage location (e.g., data stores 221 and/or one or more databases 500).

The computer-executable program code may instruct the one or more processors 210 to transmit a command to the mobile application engine 222 to generate a random unique identifier as a client device ID to be associated with the now-registered client device 100.

The computer-executable program code may further instruct the one or more processors 210 to transmit a command to the mobile application engine 222 to automatically generate an entitlement data structure associating the client device ID with the client device entitlement data. The data structure may comprise a lookout or mapping table 600 having a plurality of fields including client device ID, client device IP address, a specific enterprise mobile application that is launched by the registered client device 100, and any client device entitlement associated with the registered client device 100. In that way, upon a detection of a relaunching of the enterprise mobile application by the registered client device 100, the client device ID can be automatically linked to the client device 100 (e.g., via client device IP address) by mapping the appropriate key to the client device ID to the client device 100 and/or any client device entitlement.

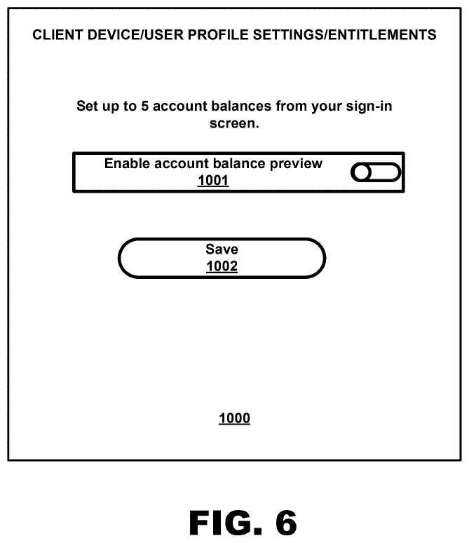

As illustrated in FIG. 6, the computer-executable program code may instruct the one or more processors 210 to transmit a command to the entitlement engine 224 to display, generate, or render a client device/user profile settings/entitlements GUI 1000 for visual display on the UI 132 of the client device 100. The client device/user profile settings/entitlements GUI 1000 may include a widget having a tile 1001 with a user-engageable toggle switch to selectively enable or disable preview of confidential or sensitive account data (e.g., current user asset data) on the UI 132 of a registered client device 100 that is unauthenticated, and a user-engageable icon 1002 to save the setting. User engagement of a save icon 1002 causes the storing of the client device entitlement data at a storage location (e.g., data stores 221 and/or one or more databases 500).

Alternatively or additionally, the client device/user profile settings/entitlements GUI 1000 may include a plurality of user input fields on the user profile registration dashboard to be populated by the user (via the client device 100) as client device entitlement data associated with the client device ID. The client device entitlement data includes an authorization by the user to bypass general user authentication protocols to display confidential or sensitive visual content associated with the user account on the UI of the client device 100 that is registered and unauthenticated.

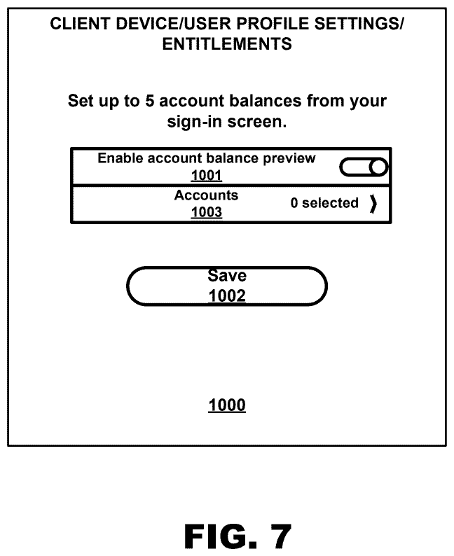

As illustrated in FIG. 7, responsive to the user selectively enabling the preview of confidential or sensitive account data (e.g., current user asset data) on the UI 132 of the client device 100 that is unauthenticated, the computer-executable program code may instruct the one or more processors 210 to update the client device/user profile settings/entitlements GUI 1000 by incorporating a tile 1003 having a user engageable arrowhead that allows the user to expand the list of user accounts to enable or disable preview of confidential or sensitive account data. In the illustrated embodiment, a threshold maximum limit of user accounts that may be enabled for preview of confidential or sensitive account data without user authentication is five. This disclosure contemplates, however, the threshold maximum limit of user accounts to be any number which optimizes or otherwise transforms the performance and functionality of the one or more embodiments in a manner that falls within the spirit and scope of the principles of this disclosure. The types of user accounts subject to preview of confidential or sensitive account data without user authentication include, but is not limited to, any user account associated with a personal account, a commercial account, and a wealth management account. Example accounts may include, but is not limited to, checking accounts, savings accounts, credit accounts, money market accounts (MMA), certificates of deposit (CD), lines-of-credit, etc.

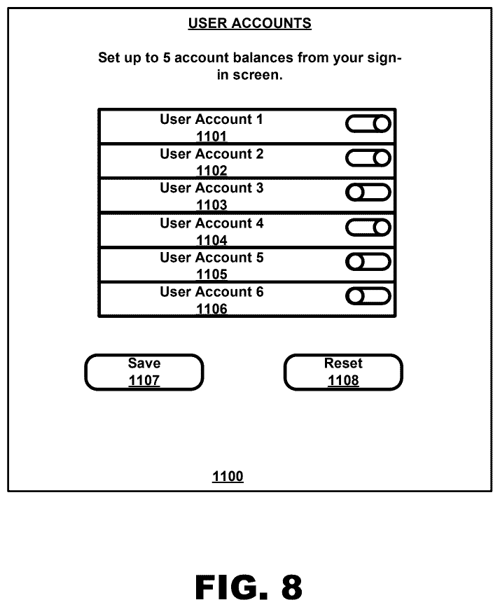

As illustrated in FIG. 8, responsive to the user selectively engaging the tile 502, the computer-executable program code may instruct the one or more processors 210 to transmit a command to the enterprise mobile application engine 222 to display, generate, or render a user accounts GUI 1100 for visual display on the UI 132 of the client device 100. The user accounts dashboard 1100 may comprise a widget having a plurality of tiles 1101-1106 that visually displays the user accounts maintained by the enterprise. Each tile 1101-1106 includes a user-engageable toggle switch to permit selective enabling or disabling via the client device 100 of one or more user accounts (up to the threshold maximum amount) that will be subject to preview of confidential or sensitive account data. The user accounts GUI 1100 also includes a user-engageable icon 1102 to save the settings, and a user-engageable icon 1103 to reset the settings. User engagement of the save icon 1102 causes the storing of the settings data at a storage location (e.g., data stores 221 and/or one or more databases 500).

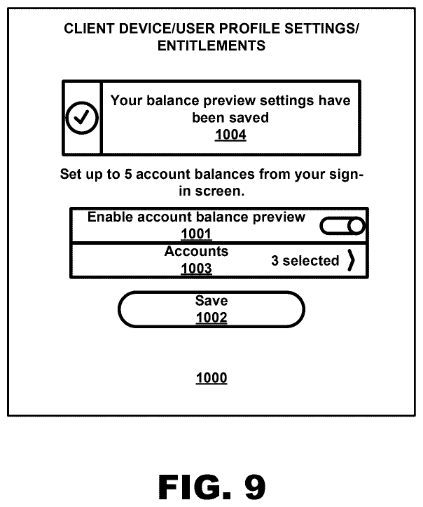

As illustrated in FIG. 9, responsive to the user engagement of the save icon 1102, the computer-executable program code may instruct the one or more processors 210 to automatically update the client device/user profile settings/entitlements GUI 1000 by incorporating a widget 1004 that visually indicates or confirms the updating of the client device entitlement data to include specific user accounts. The tile 1003 is also updated to visually indicate the overall number of user accounts 1101-1106 that have been enabled to permit preview of confidential or sensitive account data.

In accordance with one or more embodiments set forth, described, and/or illustrated herein, the computer-executable program code may also instruct the one or more processors 210 to store (e.g., in the one or more data stores 221 and/or the one or more databases 500) the user data, including the client device authentication data, user asset data, and client device entitlement data.

In accordance with one or more embodiments set forth, described, and/or illustrated herein, the computer-executable program code may, subsequent, i.e., temporally after completion of user profile registration via the client device 100 and logging out of the enterprise mobile application, instruct the one or more processors 210 to automatically detect a relaunching of the enterprise mobile application by the unauthenticated registered client device 100. The detection of the launching of the enterprise mobile application may comprise receiving an applications launch event signal from the mobile application engine 222 indicating the launching of the enterprise mobile application by the unauthenticated registered client device 100. Alternatively or additionally, detection of the launching of the enterprise mobile application may comprise receiving a backend call from the API 400 indicating the launching of the enterprise mobile application by the unauthenticated registered client device 100. Such detection may occur in instances where the enterprise mobile application is running in the background of the client device 100. Alternatively or additionally, detection may be conducted based on a detection of metadata that includes one or more of: the electronic footprint of the enterprise mobile application, and the client device information (e.g., hardware type, OS, and client device name, etc.).

In accordance with one or more embodiments set forth, described, and/or illustrated herein, the computer-executable program code may, responsive to the detection, instruct the one or more processors 210 to verify the identity of the unauthenticated registered client device 100 by mapping the unauthenticated registered client device 100 to the client device ID via the mapping table 600. The computer-executable program code may, responsive to a successful verification, instruct the one or more processors 210 to automatically apply the entitlement rule associated with the unauthenticated registered client device 100 and transmit a push notification that displays the visual content on the UI 132 of the unauthenticated registered client device 100.

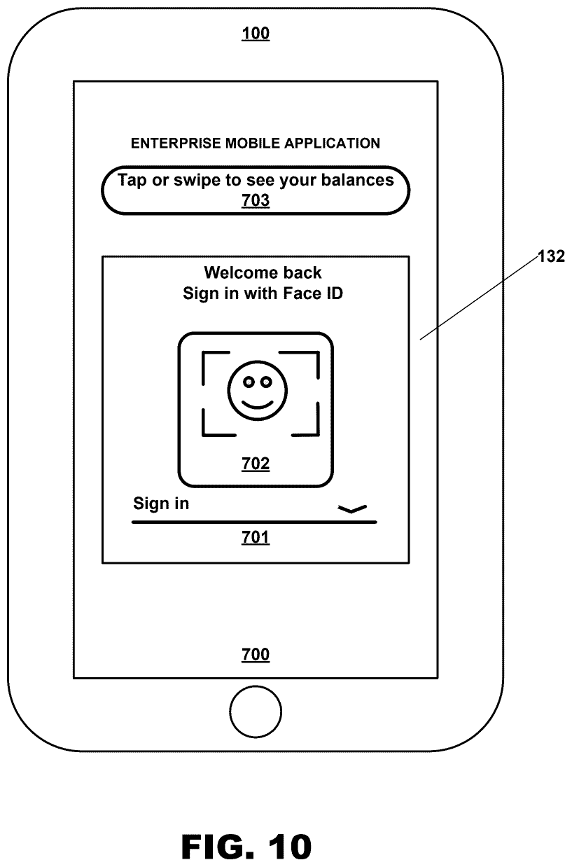

Alternatively, as illustrated in FIG. 10, the computer-executable program code may, responsive to a successful verification, instruct the one or more processors 210 to apply the entitlement rule associated with the unauthenticated registered client device 100 and update the homepage GUI 700 by incorporating a user-engageable icon 703 for visual display on the UI 132 of the client device 100. When data is received and/or modified via the user and/or the client device 100, the computer-executable program code may instruct the one or more processors 210 to automatically update the lookup table or mapping table.

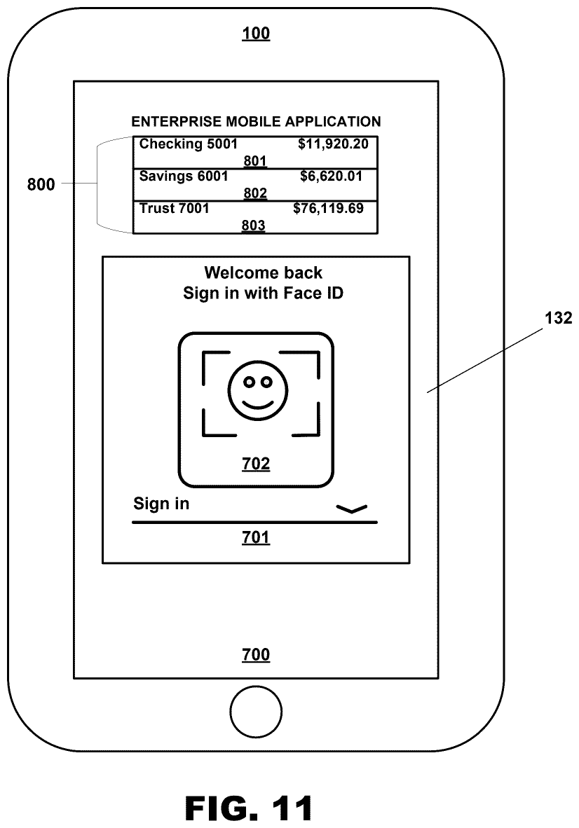

As illustrated in FIG. 11, the computer-executable program code may, responsive to a successful verification and/or user engagement of the icon 703 (FIG. 10), instruct the one or more processors 210 to transmit a command to the enterprise mobile application engine 222 to update the homepage GUI 700 and generate or render a push notification 800 that displays the confidential visual content on the UI 132 of the unauthenticated registered client device 100. The push notification 800 comprises a widget having one or more tiles 801, 802, 803 that visually displays confidential or sensitive account data on the UI 132 of the unauthenticated registered client device 100.

The computer-executable program code may instruct the one or more processors 210 to transmit a command to the enterprise mobile application engine 222 to have the push notification 800 displayed for a predetermined time value that is stored at a storage location (e.g., data stores 221 and/or one or more databases 500). The predetermined time value may be set by the enterprise mobile application engine 222 or by the user via the client device 100. The one or more processors 210 may receive a signal from a clock 250 indicating the expiration of the predetermined time value, which then causes the automatic removal of the push notification.

The computer-executable program code may instruct the one or more processors 210 to transmit a command to the enterprise mobile application engine 222 to detect an overlapping condition in which the displayed confidential visual content of the push notification overlaps and obscures displayed visual content on the homepage GUI 700 of the enterprise mobile application. The computer-executable program code may instruct the one or more processors 210 to transmit a command to the enterprise mobile application engine 222 to calculate the overall area of the push notification, locate an alternative region in the homepage GUI 700 having a calculated area that that does not present an overlapping condition, and then automatically relocate the confidential visual content to the alternative region.

Alternatively or additionally, the computer-executable program code may instruct the one or more processors 210 to transmit a command to the enterprise mobile application engine 222 to change the orientation of the push notification 800 in a manner that the visually displayed confidential or sensitive account data that either does not present an overlapping condition either or conform to a size of an alternative region.

Alternatively or additionally, the computer-executable program code may instruct the one or more processors 210 to transmit a command to the enterprise mobile application engine 222 to automatically reduce to the overall size (i.e., area) of the push notification 800 with a corresponding change in font size of the visually displayed confidential or sensitive account data in a manner that either does not present an overlapping condition either or conform to a size of an alternative region.

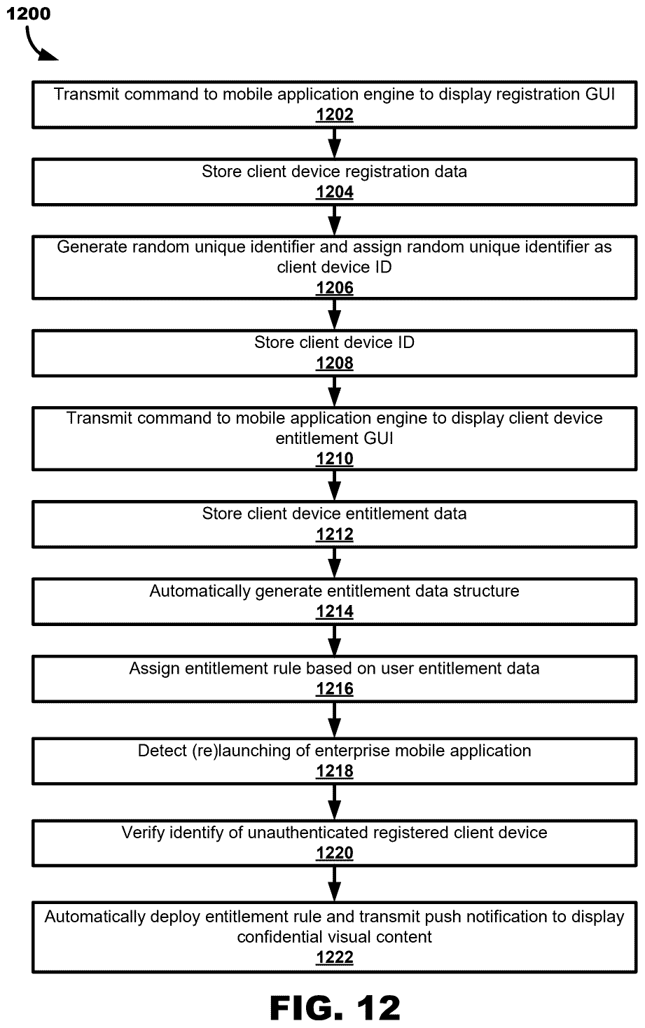

Illustrated examples shown in FIGS. 12 to 15 set forth computer-implemented methods 1200, 1300, 1400, and 1500. In one or more examples, the respective flowcharts of the computer-implemented methods 1200, 1300, 1400, and 1500 may be implemented by the one or more processors 210 of the one or more mobile application servers 200. In particular, the computer-implemented methods 1200, 1300, 1400, and 1500 may be implemented as one or more modules in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

In accordance with one or more embodiments set forth, described, and/or illustrated herein, software executed by the one or more mobile application servers 200 provides functionality described or illustrated herein. In particular, software executed by the one or more processors 210 is operable to perform one or more processing blocks of the computer-implemented methods 1200, 1300, 1400, and 1500 set forth, described, and/or illustrated herein, or provides functionality set forth, described, and/or illustrated.

As illustrated in FIG. 12, illustrated process block 1202 includes transmitting/sending a command to the mobile application engine to display, via the enterprise mobile application, a client device registration GUI on a client device, the client device registration GUI having a plurality of input data fields to acquire client device registration data that registers the client device with the enterprise mobile application as a registered client device.

The computer-implemented method 1200 may then proceed to illustrated process block 1204, which includes storing, by the mobile application engine, the client device registration data at a data storage location.

The computer-implemented method 1200 may then proceed to illustrated process block 1206, which includes generating, by the mobile application engine, a random unique identifier associated with a registered client device as a client device ID.

The computer-implemented method 1200 may then proceed to illustrated process block 1208, which includes storing, by the mobile application engine, the client device ID at a data storage location.

The computer-implemented method 1200 may then proceed to illustrated process block 1210, which includes transmitting/sending a command to the entitlement engine to display, via the enterprise mobile application, a client device entitlement GUI on the UI of the registered client device, the client device entitlement GUI having a plurality of input data fields to acquire client device entitlement data including an authorization to display confidential visual content associated with a user account on the UI of the registered client device in an unauthenticated state as an unauthenticated registered client device.

The computer-implemented method 1200 may then proceed to illustrated process block 1212, which includes storing the client device entitlement data at the data storage location.

The computer-implemented method 1200 may then proceed to illustrated process block 1214, which includes automatically generating, by the mobile application engine, an entitlement data structure associating the client device ID with the client device entitlement data.

The computer-implemented method 1200 may then proceed to illustrated process block 1216, which includes assigning, by the entitlement engine, an entitlement rule based on the client device entitlement data.

The computer-implemented method 1200 may then proceed to illustrated process block 1218, which includes detecting a (re)launching of the enterprise mobile application by the unauthenticated registered client device.

The computer-implemented method 1200 may then proceed to illustrated process block 1220, which includes verifying the identity of the unauthenticated registered client device by mapping the unauthenticated registered client device to the client device ID.

The computer-implemented method 1200 may then proceed to illustrated process block 1222, which includes automatically deploying the entitlement rule associated with the unauthenticated registered client device and transmitting a push notification that displays the confidential visual content on the UI of the unauthenticated registered client device.

The computer-implemented method 1200 may terminate or end after execution of process block 1222.

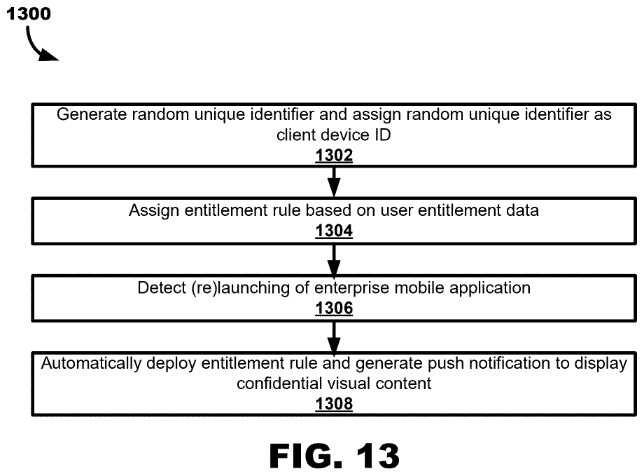

As illustrated in FIG. 13, illustrated process block 1302 includes generating, by the mobile application engine, a random unique identifier associated with a registered client device as a client device ID.

The computer-implemented method 1300 may then proceed to illustrated process block 1304, which includes assigning, by the entitlement engine, an entitlement rule based on the client device entitlement data.

The computer-implemented method 1300 may then proceed to illustrated process block 1306, which includes detecting a (re)launching of the enterprise mobile application by the unauthenticated registered client device.

The computer-implemented method 1300 may then proceed to illustrated process block 1308, which includes automatically deploying the entitlement rule associated with the unauthenticated registered client device and transmitting a push notification that displays the confidential visual content on the UI of the unauthenticated registered client device.

The computer-implemented method 1300 may terminate or end after execution of process block 1308.

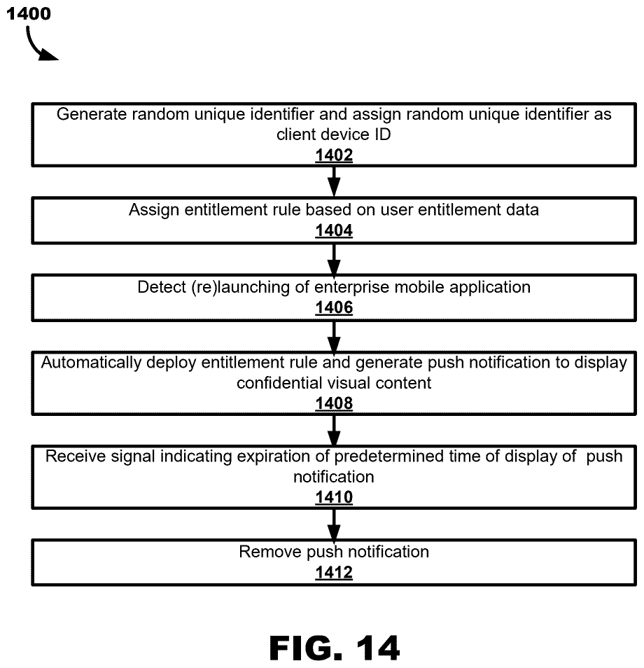

As illustrated in FIG. 14, illustrated process block 1402 includes generating, by the mobile application engine, a random unique identifier associated with a registered client device as a client device ID.

The computer-implemented method 1400 may then proceed to illustrated process block 1404, which includes assigning, by the entitlement engine, an entitlement rule based on the client device entitlement data.

The computer-implemented method 1400 may then proceed to illustrated process block 1406, which includes detecting a (re)launching of the enterprise mobile application by the unauthenticated registered client device.

The computer-implemented method 1400 may then proceed to illustrated process block 1408, which includes automatically deploying the entitlement rule associated with the unauthenticated registered client device and transmitting a push notification that displays the confidential visual content on the UI of the unauthenticated registered client device.

The computer-implemented method 1400 may then proceed to illustrated process block 1410, which includes receiving a signal from a clock indicating the expiration of a predetermined period of time of display of the push notification.

The computer-implemented method 1400 may then proceed to illustrated process block 1412, which includes automatically removing the push notification.

The computer-implemented method 1400 may terminate or end after execution of process block 1412.

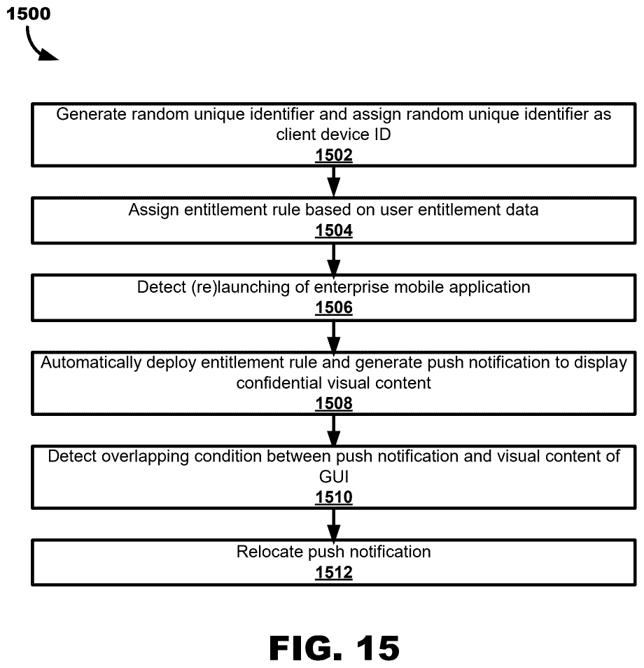

As illustrated in FIG. 15, illustrated process block 1502 includes generating, by the mobile application engine, a random unique identifier associated with a registered client device as a client device ID.

The computer-implemented method 1500 may then proceed to illustrated process block 1504, which includes assigning, by the entitlement engine, an entitlement rule based on the client device entitlement data.

The computer-implemented method 1500 may then proceed to illustrated process block 1506, which includes detecting a (re)launching of the enterprise mobile application by the unauthenticated registered client device.

The computer-implemented method 1500 may then proceed to illustrated process block 1508, which includes automatically deploying the entitlement rule associated with the unauthenticated registered client device and transmitting a push notification that displays the confidential visual content on the UI of the unauthenticated registered client device.

The computer-implemented method 1500 may then proceed to illustrated process block 1510, which includes detecting an overlapping condition in which the displayed confidential visual content overlaps displayed visual content on a GUI of the enterprise mobile application.

The computer-implemented method 1500 may then proceed to illustrated process block 1512, which includes automatically relocating, in response to the detection, the confidential visual content to an alternative region that does not present an overlapping condition.

The computer-implemented method 1500 may terminate or end after execution of process block 1512.

Devices that are described as in “communication” with each other or “coupled” to each other need not be in continuous communication with each other or in direct physical contact, unless expressly specified otherwise. On the contrary, such devices need only transmit to each other as necessary or desirable, and may actually refrain from exchanging data most of the time. For example, a machine in communication with or coupled with another machine via the Internet may not transmit data to the other machine for long period of time (e.g. weeks at a time). In addition, devices that are in communication with or coupled with each other may communicate directly or indirectly through one or more intermediaries.

The terms “coupled,” “attached,” or “connected” may be used herein to refer to any type of relationship, direct or indirect, between the components in question, and may apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the exemplary embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A server computing system, comprising:
one or more mobile application server computers including a plurality of processor-implemented engines including a mobile application engine for an enterprise mobile application, an authentication engine having general user authentication protocols for the enterprise mobile application, and an entitlement engine, one or more processors, and a non-transitory memory coupled to the one or more processors, the non-transitory memory including a set of instructions of computer-executable program code, which when executed by the one or more processors, cause the one or more processors to perform operations including:
generating, by the mobile application engine, a random unique identifier associated with a registered client device as a client device ID,
assigning, by the entitlement engine, an entitlement rule associated with an unauthenticated registered client device based on client device entitlement data,
detecting, by the mobile application engine, a launching of the enterprise mobile application by the unauthenticated registered client device, and
automatically deploying the entitlement rule and transmitting a push notification that displays the confidential visual content on the UI of the unauthenticated registered client device.

2. The server computing system of claim 1, wherein the set of instructions, which when executed by the one or more processors, cause the one or more processors to perform further operations including transmitting a command to the mobile application engine to display, via the enterprise mobile application, a client device registration graphical user interface (GUI) on a client device, the client device registration GUI having a plurality of input data fields to acquire client device registration data that registers the client device with the enterprise mobile application as a registered client device.

3. The server computing system of claim 1, wherein the set of instructions, which when executed by the one or more processors, cause the one or more processors to perform further operations including transmitting a command to the entitlement engine to display, via the enterprise mobile application, a client device entitlement GUI on the registered client device, the client device entitlement GUI having a plurality of input data fields to acquire client device entitlement data including an authorization to display confidential visual content associated with a user account on the UI of the registered client device in an unauthenticated state as an unauthenticated registered client device.

4. The server computing system of claim 1, wherein the set of instructions, which when executed by the one or more processors, cause the one or more processors to perform further operations including automatically generating, by the mobile application engine, an entitlement data structure associating the client device ID with the client device entitlement data.

5. The server computing system of claim 4, wherein the set of instructions, which when executed by the one or more processors, cause the one or more processors to perform further operations including verifying the identity of the unauthenticated registered client device by mapping, via the entitlement data structure, the unauthenticated registered client device to the client device ID.

6. The server computing system of claim 1, wherein the push notification is displayed on the UI of the unauthenticated registered client device for a predetermined time value that is stored at a storage location.

7. The server computing system of claim 6, wherein the set of instructions, which when executed by the one or more processors, cause the one or more processors to perform further operations including receiving a signal from a clock indicating the expiration of the predetermined time value.

8. The server computing system of claim 7, wherein the set of instructions, which when executed by the one or more processors, cause the one or more processors to perform further operations including automatically removing the push notification.

9. The server computing system of claim 1, wherein the set of instructions, which when executed by the one or more processors, cause the one or more processors to perform further operations including detecting an overlapping condition in which the displayed confidential visual content overlaps displayed visual content on a GUI of the enterprise mobile application.

10. The server computing system of claim 9, wherein the set of instructions, which when executed by the one or more processors, cause the one or more processors to perform further operations including automatically relocating, in response to the detection, the confidential visual content to an alternative region of the UI of the unauthenticated registered client device that does not present an overlapping condition.

11. The server computing system of claim 1, wherein the push notification is superimposed on a GUI of the enterprise mobile application.

12. The server computing system of claim 1, wherein the push notification is superimposed on a GUI of the enterprise mobile application at a predetermined region of the UI of the unauthenticated registered client device.

13. The server computing system of claim 12, wherein the predetermined region does not display visual content to be overlapped by the push notification.

14. The server computing system of claim 1, wherein the push notification is superimposed on a GUI of the enterprise mobile application at a randomly selected region of the UI of the unauthenticated registered client device.

15. The server computing system of claim 1, wherein the confidential visual content comprises current user asset data.

16. The server computing system of claim 1, wherein the confidential visual content comprises user account transaction history.

17. The server computing system of claim 1, wherein detecting the launching comprises receiving an applications launch event signal from the mobile application engine indicating the launching of the enterprise mobile application by the unauthenticated registered client device.

18. The server computing system of claim 1, wherein detecting the launching of the enterprise mobile application comprises receiving a backend call from an application program interface (API) indicating the launching of the enterprise mobile application by the unauthenticated registered client device.

19. A method for implementation by a server computing system, the method comprising:
generating, by a mobile application engine of the server computing system, a random unique identifier associated with a registered client device as a client device ID;
assigning, by an entitlement engine of the server computing system, an entitlement rule associated with an unauthenticated registered client device based on client device entitlement data;
detecting, by a mobile application engine of the server computing system, a launching of an enterprise mobile application by the unauthenticated registered client device; and
automatically deploying, by the entitlement engine of the server computing system, the entitlement rule and transmitting a push notification that displays the confidential visual content on the UI of the unauthenticated registered client device.

20. A computer program product comprising at least one non-transitory computer readable medium having with a set of instructions of computer-executable program code, which when executed by one or more processors of a server computing system, cause the one or more processors to perform operations including:
generating, by a mobile application engine of the server computing system, a random unique identifier associated with a registered client device as a client device ID;
assigning, by an entitlement engine of the server computing system, an entitlement rule associated with an unauthenticated registered client device based on client device entitlement data;
detecting, by a mobile application engine of the server computing system, a launching of an enterprise mobile application by the unauthenticated registered client device; and
automatically deploying, by the entitlement engine of the server computing system, the entitlement rule and transmitting a push notification that displays the confidential visual content on the UI of the unauthenticated registered client device.
